(19) United States
(12) Patent Application Publication
(10) Pub. No.: US 2018/0003028 A1
(43) Pub. Date: Jan. 4, 2018

(54) DOWNHOLE MEASUREMENT SYSTEM

(71) Applicant: New Mexico Tech Research Foundation, Socorro, NM (US)

(72) Inventors: Robert Balch, Socorro, NM (US); Tongjun Ruan, Socorro, NM (US)

(21) Appl. No.: 15/633,273

(22) Filed: Jun. 26, 2017

Related U.S. Application Data
(60) Provisional application No. 62/356,476, filed on Jun. 29, 2016.

(51) Int. Cl. E21B 47/00; G01P 1/00; G01P 21/00; G01P 15/18; E21B 7/04; E21B 29/00

(52) U.S. Cl. CPC E21B 47/00; G01P 21/00; G01P 15/18; G01P 1/006; E21B 29/002; E21B 7/046

(57) ABSTRACT

A downhole measurement system includes a data logger. The data logger includes a containment vessel containing a processor, an accelerometer, and memory. The containment vessel is characterized by a radial dimension less the diameter of a hole to be measured. The processor is operative to execute processor-readable instructions. The accelerometer is in data communication with the processor, and is operative to measure acceleration along three mutually orthogonal axes. The accelerometer is operative to output, to the processor, data characterizing the measured acceleration. The memory, in data communication with the processor, is operative to store processor-readable instructions. The stored instructions include processor-readable instructions, that when executed by the processor, cause the processor to receive the outputted acceleration data and write the received acceleration data to the memory.

### RELATED APPLICATION

This application claims priority to U.S. Provisional Patent Application No. 62/356,476, filed Jun. 29, 2016 and entitled “Three-Axis Acceleration Data Logger.” The complete disclosure of the above-identified priority application is hereby fully incorporated herein by reference.

### TECHNICAL FIELD

The technology disclosed herein is related to systems and methods for measuring characteristics of wells. Specific embodiments relate to measuring the length of holes drilled laterally to a main wellbore.

### BACKGROUND

The effort to drill lateral to a wellbore dates back nearly one hundred years, almost to the dawn of the modern oil and gas industry. In the mid-twentieth century, one person who attempted the task declared it “not possible in actual practice.” In spite of the difficulty of such drilling, starting in the mid-1990s, a wave of entrepreneurs proposed to create radial boreholes to reach untapped pay zones by means of a hose and a jetting nozzle. Such jetting systems typically may be deployed by coiled tubing units. Most of these systems may employ some sort of downhole whipstock secured on the end of production tubing. The whipstock may direct the tools toward the casing and the formation, and may usually stay in place for the duration of the procedure. The attractiveness of the jetting systems may stem from the fact that hoses are inherently flexible and should be able to easily transition around the tight radius of the whipstock. Some jetting companies advertise lateral distance of up to 300 ft. and targeted well recompletion and infill replacement.

Jet drilling may utilize a casing drill and a water jet deployed through a 1 in. coiled tubing unit. Water may be pumped through the coiled tubing and then pushed under pressure through micro jets on a cutting head. The jet tip and water supply hose typically are 0.5 in. in diameter. Cutting jets on the tip eat away at carbonate rock or carbonate cemented sandstones. Drive jets push the jet tip and may pull the hose up to 300 ft. lateral from the wellbore, helping to flush rock residue from the lateral. When the technology works, a jagged ˜1 in. diameter jetted lateral may result in increased drainage in the well. Since jetting systems are not typically capable of forming a hole through the metal casing, the first step typically involves running casing milling tools around the radius of the whipstock. These casing cutting tools then may be retracted from the well and the jetting tools may be affixed to the end of a hose and run downhole. The nozzles used on these systems typically are adapted from the sewer cleaning industries, and some are stationary, while more advanced implementations may rotate or may create a swirling spray pattern. High-pressure fluid (typically weak acid, or fresh water and potassium chloride) used in jetting systems then may be pumped through the nozzle in an attempt to erode the rock.

Mechanical lateral drilling systems may use interlocking toothed segments that, when combined into a tool string, may create a flexible drilling string able to make a right turn in a shoe installed in a wellbore. Such mechanical lateral drilling systems may be deployed on cased or open-hole completed wells, and may use a milling bit to first create a hole in the casing. After creating a hole in the casing, the milling bit may be pulled and the lateral drill may be attached and run downhole. Some lateral drills can drill out at 90° from 5.5 in. or larger casing, and at higher angles from smaller casing. This may put into play the majority of mature stripper wells in the U.S. The lateral drill may then create a hole in the pay zone by utilizing a rotating, mechanical drill bit on the end of the lateral drill string. The drilling bit may be carbide or PDC, so it can cut very hard zones, including chert and clasts. The conduit may be used to provide lubricating fluid to the cutting head encased in a type of metal exoskeleton whose metal cladding typically accomplishes several purposes including: protection of the stainless steel hose from abrasion; assistance in assuring the cutting head drills straight, and transferal of weight on bit (WOB) to the drill head to cut the formation.

Some mechanical lateral drills can meet most of the claims of liquid jet drilling, most importantly: improved fluid communication between the pay zone and wellbore, by-pass of near-wellbore damage, and provision of a conduit to push chemicals/treatments into the zone. Additional potential applications include mitigation of water-coning, treatment of carbonate zones with hydrochloric acid to create wormholes, orientation of laterals to preferentially intersect fracture planes, and in lieu of or as a precursor (e.g. to prevent screen-out) to certain fracturing jobs or where fracturing is under a moratorium.

### SUMMARY

Embodiments of the technology disclosed herein include methods, systems, and computer program products, to measure the characteristics of well holes, including holes drilled substantially lateral to a wellbore.

In some embodiments, a downhole measurement system includes a data logger. The data logger includes a containment vessel containing a processor, an accelerometer, and memory. The containment vessel is characterized by a radial dimension less the diameter of a hole to be measured. The processor is operative to execute processor-readable instructions. The accelerometer is in data communication with the processor, and is operative to measure acceleration along three mutually orthogonal axes. The accelerometer is operative to output, to the processor, data characterizing the measured acceleration. The memory, in data communication with the processor, is operative to store processor-readable instructions. The stored instructions include processor-readable instructions, that when executed by the processor, cause the processor to receive the outputted acceleration data and write the received acceleration data to the memory.

In some embodiments, a downhole measurement system includes a computer program product that is a non-transitory computer-readable storage device having computer-executable program instructions embodied thereon that when executed by a computer cause the computer to determine spatial characteristics of the measured hole as a function of acceleration data written to the memory. In such embodiments, the computer-executable program instructions, when executed by the computer, cause the computer to integrate the acceleration data written to the memory over time, thereby determining velocity data of the data logger; and to integrate the velocity data over time, thereby determining position data of the data logger.

These and other aspects, objects, features, and advantages of the example embodiments will become apparent to those having ordinary skill in the art upon consideration of the following summary description of illustrated example embodiments.

### BRIEF DESCRIPTION OF THE DRAWINGS

FIG. 1 is a block diagram depicting an operating environment of a downhole measurement system to determine the disposition of well bores, in accordance with certain example embodiments.

FIG. 2 is a schematic diagram of a data logger of the downhole measurement system, in accordance with certain example embodiments.

FIG. 3 depicts dimension of a containment vessel of the downhole measurement system, in accordance with certain example embodiments.

FIG. 4 is block flow diagram depicting a method to determine the disposition of well bores, in accordance with certain example embodiments.

FIG. 5 is block flow diagram depicting a method to determine the disposition of well bores, in accordance with certain example embodiments.

FIG. 6 is block flow diagram depicting a method to determine the disposition of well bores, in accordance with certain example embodiments.

FIG. 7 is a block diagram depicting a computing machine and a module, in accordance with certain example embodiments.

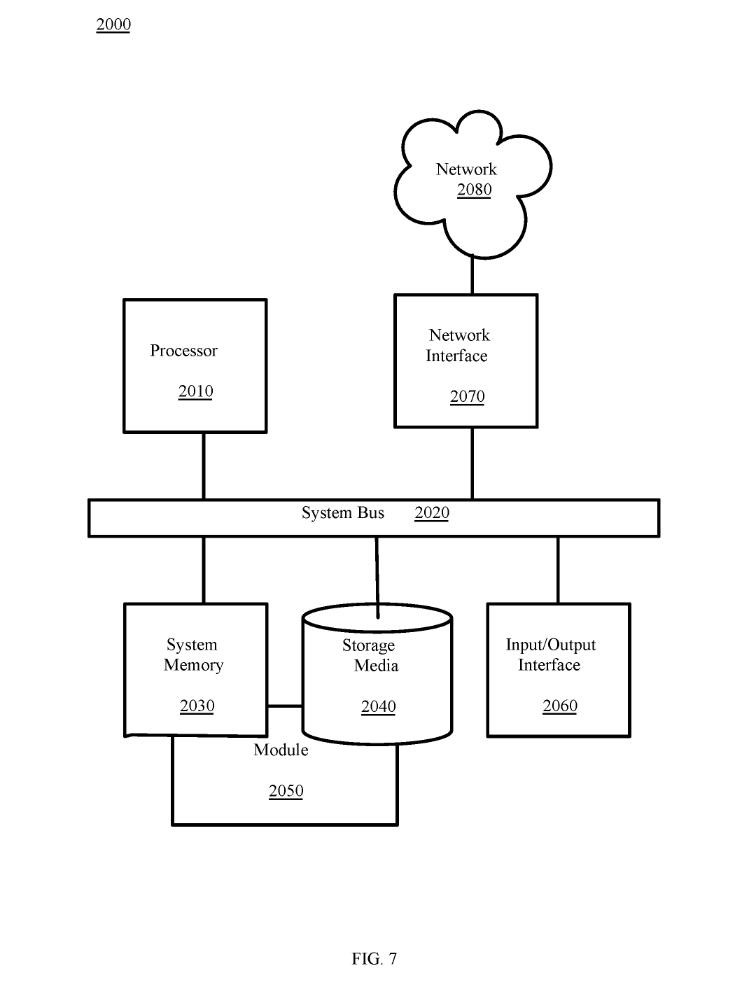

### DETAILED DESCRIPTION OF THE EXAMPLE EMBODIMENTS

In most lateral drilling systems, there was uncertainty of whether and how far the nozzle had actually jetted out. By using and relying on the methods and systems described herein, the technology disclosed herein a well driller can determine the disposition of laterals created by fluid jet and mechanical lateral drills. While example embodiments are disclosed herein in conjunction with both fluid jet and mechanical lateral boring, some embodiments of the invention can be used with any lateral boring technology and in wellbores other than lateral wellbores.

Turning now to the drawings, in which like numerals represent like (but not necessarily identical) elements throughout the figures, example embodiments are described in detail.

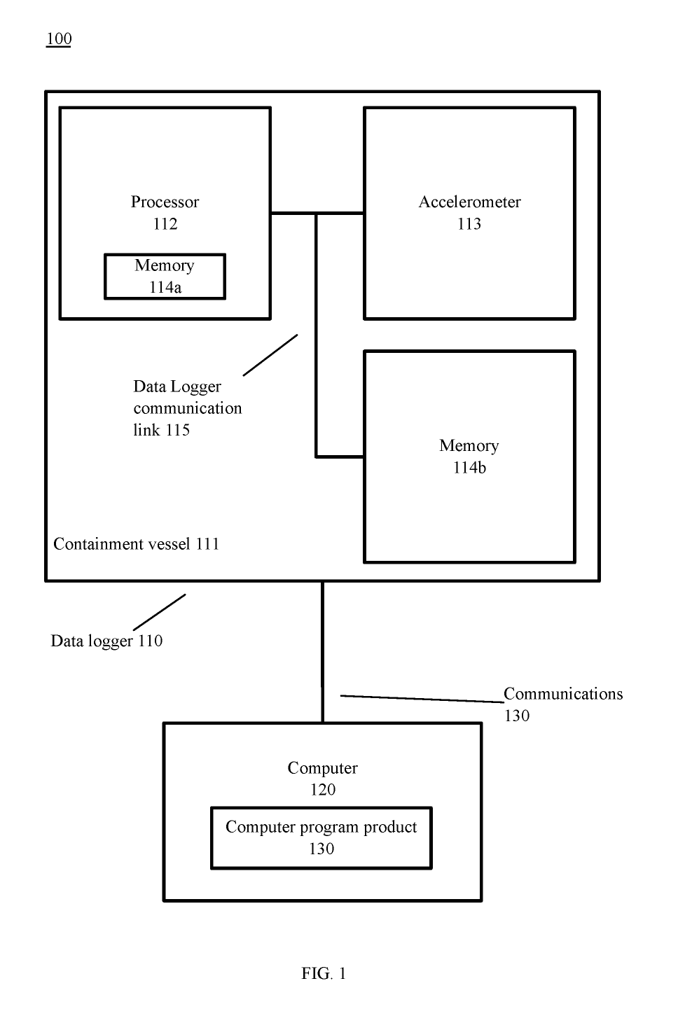

FIG. 1 is a block diagram depicting an operating environment of a downhole measurement system 100, in accordance with certain example embodiments. While each element shown is represented by one instance of the element, multiple instances of each can be used. Further, while certain aspects of operation of the present technology are presented in examples related to FIG. 1 to facilitate enablement of the claimed invention, additional features of the present technology, also facilitating enablement of the claimed invention, are disclosed elsewhere herein.

As depicted in FIG. 1, a downhole measurement system 100 can include a data logger 110 and a computer program product 130 to analyze the data collected by the data logger 110. The data logger 110 includes a containment vessel 111 containing a processor 112, an accelerometer 113, memory 114 (divided into memory 114a embedded in the processor 112 and memory 114b outside the processor 112), and data logger communications 115. The containment vessel 111 is characterized by a radial dimension less the diameter of a hole to be measured. The processor 112, housed in the containment vessel 110, is operative to execute processor-readable instructions.

The accelerometer 113, also housed in the containment vessel 111, is in data communication with the processor 112 over data logger communication 115, and is operative to measure acceleration along three mutually orthogonal axes. The accelerometer 113 outputs to the processor 112, data characterizing the measured acceleration. The memory 114b is housed in the processor 112 in the containment vessel 111. The memory 114a, housed on the processor 112 in the containment vessel 110, stores processor-readable instructions (though in some embodiments, some or all of such instructions are stored in memory 114b). The instructions stored in memory 114a, when executed by the processor 112, cause the processor 112 to receive the outputted acceleration data, and to write the received acceleration data to the memory 114b (though in some embodiments, some or all of such data are written to memory 114a).

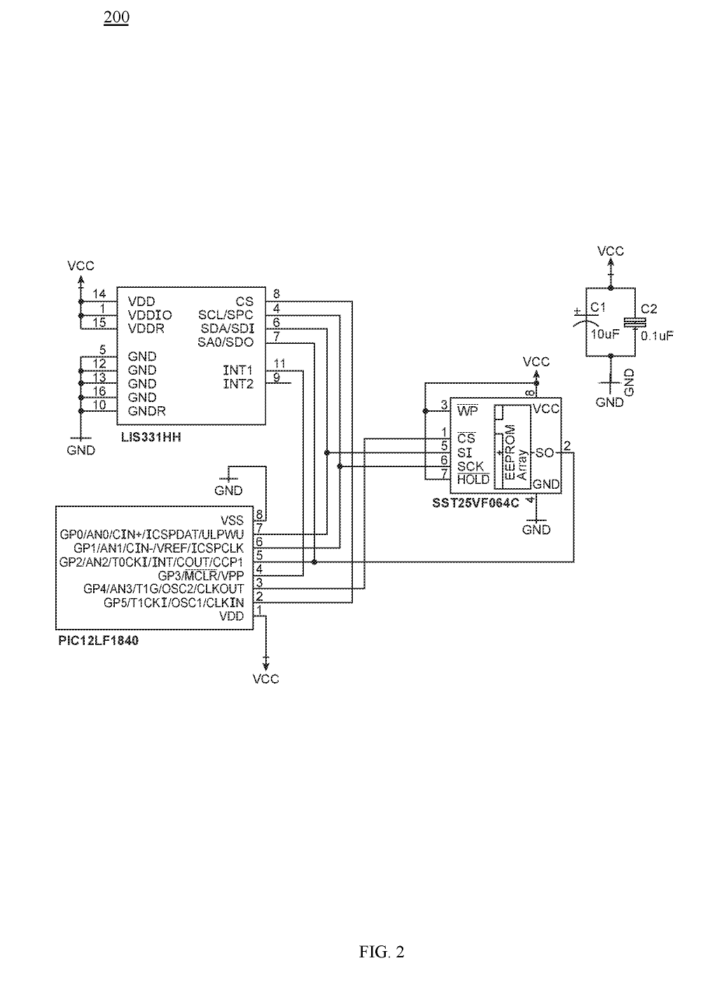

Consider, as a continuing example, the data logger represented by the schematic of FIG. 2. FIG. 2 shows a PIC12LF1840 controller from Microchip Technology, Inc. as the processor 112 (including program memory 114a), an LIS331DLH three-axis micro-electro-mechanical systems (MEMS) accelerometer from ST Microelectronics as the accelerometer 113, an SST25VF064C serial flash memory from Microchip Technology, Inc. as the data memory 114b, along with two capacitors across the voltage supply.

The PIC12LF1840 controller is characterized by a small outline integrated circuit (SOIC) package (narrow 3.9 mm body) or dual-flat no-lead (DFN) package (3 mm×3 mm×0.9 mm body), both with eight pins, low voltage (1.8 V-3.6 V), low power consumption (a current draw of 75 μA), 4K word program memory 114a, and an external interface supporting serial peripheral interface (SPI) and a Inter-Integrated Circuit (I2C) communication channel 115. Additionally, Microchip Technology, Inc. provides development tools: an Integrated Development Environment including a C compiler and programmer.

The LIS331DLH accelerometer is an ultra low-power, high performance, three-axis linear accelerometer belonging to the “nano” family; with digital I2C/SPI serial interface standard input/output (I/O). The device features ultra low-power operational modes that allow advanced power saving and smart sleep to wake-up functions. LIS331 has a 12-bit sample rate corresponding to 50-1,000 samples per second. The LIS331DLH also has dynamically user-selectable full scales of ±2 g/±4 g/±8 g and it is capable of measuring accelerations with a 12-bit sample rate of 50-1,000 samples per second while utilizing a self-test capability that allows the user to check the functioning of the sensor in the final application. In addition, the device may be configured to generate an interrupt signal by inertial wake-up/free-fall events as well as by the position of the device itself. Thresholds and timing of the interrupt generators are programmable by the end user. The LIS331DLH is available in small thin plastic land grid array (LGA) packages (3 mm×3 mm×1 mm) and can operate over an extended temperature range from −40° C. to +85° C., which encompasses most oilfield deployments. Using the LIS331DLH as the accelerometer 113 does not require an extra amplifier/conditioner, coaxial cable, constant current source, or an analog-to-digital converter, because all these elements are integrated into it.

The 64 Mbit (8 Mbyte) SST25VF064C serving as the data memory 114b in the continuing example, is a 5 mm×5 mm flash memory in a 8-pin SOIC package, with an SPI/I2C interface. It is a low-power, low voltage (2.7 V-3.6 V), high speed read (33-80 MHz) flash memory, with long endurance (100,000 cycles, typical), and great data retention (greater than 100 years). Assuming the sampling rate of the LIS331DLH is set at 100 samples/second, at every second, the data logger 110 will generate 100×6 bytes=600 bytes (each sampling data set contains 6 bytes for x, y, and z directions). Eight MB divided by 600 bytes/second gives 13,333 seconds of capacity, or 3.7 hours, which is sufficient for deployment of coiled tubing in and out of a well.

Several discrete devices shown in FIG. 2 are used in the connections between the sensor, microcontroller and flash memory chip to make the data logger 110 work properly.

Since the accelerometer 113, processor, 112, and memory 114b of the continuing example all work at about 3 V, to power the data logger 110 a 3 V battery that meets the size requirements (for the continuing example, a diameter less than 10.9 mm and height/thickness less than 5 mm) is useful. Coin-shaped cells will fit. In particular, the lithium cell CR1025, with a 3 V voltage, 30 mAh current rating, and dimensioned 10 mm dia.×2.5 mm thick was chosen for the continuing example. Lithium batteries have better discharge characteristics than alkaline batteries.

The C-rate is the measure of the rate at which a battery is discharged relative to its maximum capacity. A 1C rate means that the discharge current will discharge the entire battery in 1 hour. For a battery such as the CR1025, with a capacity of 30 mA-hrs. This equates to a discharge current of 30 mA. Most portable batteries, with the exception of lead acid, are rated at 1C. The same battery discharged at 0.5 C provides 15 mA for two hours. At 2 C, the same battery delivers 60 mA for 30 minutes. A breakdown of power budget by component is shown in Table 1.

TABLE 1
Size and Power Consumption by Component

| | | | | | | | | | Resistor/ |
|---|---|---|---|---|---|---|---|---|---|
| Name | PIC12LF1840 | | LIS331 | | SST25VF064C | | Battery | | Capacitor |
| Size | 3.9 mm × 3.9 mm | | 3 × 3 × 1 | mm | 5 × 5 | mm | 10 × 2.5 | mm | 3 × 2 mm |
| | (SOIC body) | | | | | | | | |
| Operation | 1.8-3.6 | V | 2.16-3.6 | V | 2.7-3.6 | V | Lithium 3 V | | |
| Voltage | | | | | | | | | |
| Operation | 75 | μA | 250 | μA | 25 | mA | 30 | mAH | |
| current | | | | | | | | | |

| | | | | | | |
|---|---|---|---|---|---|---|
| Standby/sleep | 500 | nA | 10 | μA | 5 | μA |

On this basis, it is possible to evaluate power consumption for the data logger 110: the operation voltages are, respectively: 1.8-3.6 V, 2.16-3.6 V, and 2.7-3.6 V so the CR1025 battery fits the operating voltage requirement. The total maximum operation current is: 75 μA+250 μA+25 mA=25.325 mA. Based on the C-rate of lithium batteries, the CR1025 can support 30/25.325=1.18 hours. However, in some embodiments, the SST25VF064C chip 114 is only enabled when being written. Bench tests show that the SST25VF064 chip is enabled less than one-third of the time in a cycle of read-write. During the enabled windows, the chip is not always in writing mode; most of its time is spent waiting and communicating with the processor 112. Therefore, the CR1025 battery should power the data logger 110 for more than 3.3 hours. Bench tests showed that the CR1025 is not exhausted after the data logger 110 has run for over 3.5 hours and the memory chip was fully written.

A tube made of T-316/316L stainless steel, (0.5 in. OD×0.035 in. wall×0.43 in. ID T-316/316L) serves as the containment vessel 111 of the data logger 110 in the continuing example. The inner diameter of the T-316/316L tube is 0.43 in.=10.9 mm. Although its theoretical bursting pressure is 10,500 lb./in.², the American Society of Mechanical Engineers (ASME) Code suggests a safety factor of four; so it is safe to use at 2625 psi bursting pressure based on temperatures between −20° F. and 100° F.

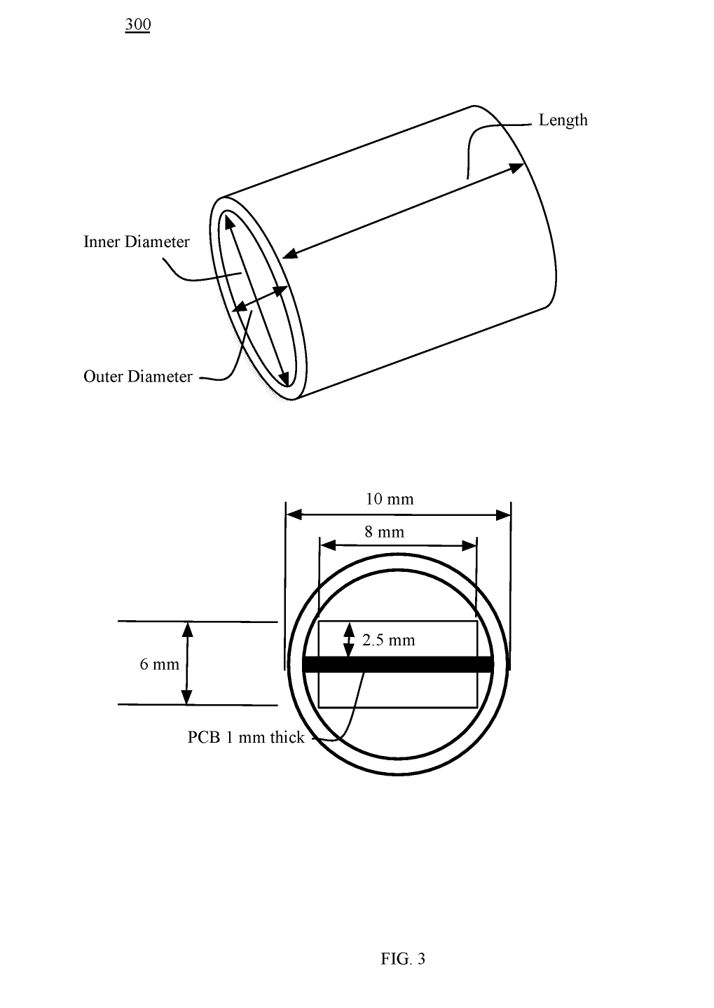

Table 1 also shows the sizes of each main component that are used to build the data logger 110. The total length of data logger 110 of the continuing example is 2.9 mm+3 mm+5 mm+2.5 mm=14.4 mm at a minimum, with a diameter of at most 10 mm. The printed circuit board dimension is equal to or less than 10 mm×25 mm. FIG. 3 illustrates continuing example containment vessel 111 dimensions.

Communication among chips 115 is one aspect of the data logger 110. Parallel communication is faster but presents challenges (e.g., uses more wires/connections) given the small design space of the containment vessel 111. All three main chips selected in the continuing example (Microcontroller PIC12VF1840, 3-Axis Accelerometer LIS331HH, and Serial Flash Memory chip SST25VF064C) have an SPI interface. SPI is a synchronous serial data link, a de facto standard, which operates in full duplex mode. Devices communicate in master/slave mode between SPI interfaces where the master device initiates the data frame. Multiple slave devices are allowed with individual slave select lines. SPI bus specifies four logic signals: SCK: Serial Clock (output from master); SDI: Master Data Output/Slave Data Input (output from master); SDO: Master Data Input/Slave Data Output (output from slave); and CS: Slave Select (active low, output from master).

The processor 112 (PIC12LF1840) has eight pins: two pins for power supply (V_{cc} and Ground) and six pins for I/O. Six I/O pins are used in the following manner: three pins (SCK, SDI, and SDO) for the SPI bus, one pin for acceleration data ready (interrupt), and two pins (CS1 and CS2) for slave chip/device selection/enable. The processor 112 (PIC12LF1840) is configured as the SPI master, with the accelerometer 113 (LIS331DLH) and the memory 114b (SST25VF064C) as SPI slaves. CS1 and CS2 are configured as chip selections respectively for accelerometer 113 and data memory 114b.

The firmware/software used in the downhole measurement system 100 configures the data logger 110, measures and records the acceleration, and analyzes the recorded data, ultimately computing the path or position by twice integrating the recorded accelerations. The software for the downhole measurement system 100 includes two parts: control firmware and data processing software.

Control firmware is written into the program memory 114a inside the processor 112, and runs on the processor 112 to configure the data logger 110 to measure accelerations, and to write acceleration data received from the accelerometer 113 until the memory 114b is full or powered off. Data processing software 130 runs on computer 120 to process recorded data and compute the path/position by integrating the recorded accelerations.

In the continuing example, the firmware functions allocated to execute on the processor 112 include the following.

In the continuing example, the control firmware configures the processor's 112 SPI bus at pins 5, 6, and 7, the interrupt function at pin 4, and the SPI slave selection pin (pin 1 for accelerometer 113 and pin 2 for memory 114b), along with setting the clock rate at 500 kHz. The control firmware configures the accelerometer 113 scale range as {−6 g, 6 g}, sampling rate as 100/sec., and data ready signal output at “inti” pin. The control firmware enables the memory 114b page program/write. The control firmware waits for the data ready signal from accelerometer 113. If the data are ready, processor 112 will respond and start reading 6-byte acceleration data from the accelerometer 113. The control firmware writes the acceleration data into the memory 114b and waits again for the data ready signal from the accelerometer 113.

Power consumption is an important issue since a battery cell powers the data logger 110. In the continuing example, the PIC12LF1840 8-bit microcontroller uses active currents of less than 50 μA/MHz, which means that the lower the clock rate is set, the less power is consumed. To save power and make sure the data logger 110 works properly with enough power during the required period, the clock rate is set as low as possible. The clock rate of PIC12LF1840 is set to 0.5 MHZ and the SPI clock rate is set to 125 kHz, so the SPI bandwidth is 125 Kbits/8→about 10.5 KB.

The following analysis shows the clock rate is sufficient for data logger 110 to work properly. The sampling rate of LIS331HH is set as 100 samples per second; each time step, six bytes of data are generated (two bytes for each axis); fewer than 10 ms are available for the interrupt service routine to read, write data and return. In total, 600 bytes data must be read from the accelerometer 113 and written into flash memory 114b per second, which means 1200 bytes on the SPI bus for read and write operations during one second. 1200 Bytes is significantly less than 10.5 KB, even when doubled overhead plus other delays caused by other operations is considered, so the 10.5 KB bandwidth is adequate. Thus, 10 ms is more than enough for the processor 112 to read and write data.

Bench tests showed that the interrupt service routine takes about 4 ms in total to complete its task after a data ready signal/interrupt appears, and then it waits about 6 ms for next data ready signal/interrupt. Recorded data in the data memory chip 114b is read out using a serial flash memory programmer SF600, which connects to the memory chip 114b (after opening the containment vessel) and also to a PC with USB cable and reads and saves data in binary format on the PC for further data processing.

In the continuing example, based upon the foregoing discussion, 600 bytes/sec. (64 Mb/8)/600→13,333 seconds→3.7 hours of data can be stored in the SST25VF64C data memory 114b. In fact, the SST25VF064C is divided into 256-byte pages and the continuous writing is limited to one page, which means the interrupt service routine must write 6 bytes on one page and not break the boundary to the next page every 10 ms. Dividing 256 by 6 gives 42; the remainder 4 bytes are left unchanged for convenient coding and quick operation. In the interrupt service routine, if the page address is 252 then it will add 4 and force it to jump to the beginning (0) of next page.

The PIC12LF1840 processor 112 has a Master Synchronous Serial Port (MSSP) module with configurable SPI/I2C bus. The MSSP module can operate in one of two modes: Serial Peripheral Interface (SPI), and Inter-Integrated Circuit (I2C). In the continuing example, the MSSP is configured to work as an SPI. Then the SPI modes for LIS331 and for SST25VF64C are configured because the SPI has four work modes (mode 0-mode 4) based on the combinations of polarity and phases of SPI clock and data signals. The accelerometer 113 used in the continuing example is designed to work with SPI mode 3 and the data memory 114b is designed to work with SPI mode 0, respectively, by their manufacturers. To be able to communicate with a slave chip properly, the processor 112 must first configure or set its SPI to work at the same mode as the slave chip.

In the data logger 110 the code first configures the SPI work in mode 3 to communicate with LIS331 and then switch to mode 0 when needing to communicate with the SST25VF64C, then switch back to mode 3 for the next accelerometer 113 operation. More details can be found in the C functions of Table 2.

The accelerometer 113 of the continuing example has internal low- and high-pass filters. The low-pass filter is fixed with the sampling rate configured on the fly. Offset can be eliminated by enabling the built-in high pass filter. To avoid gravity drift, the accelerometer 113 in the continuing example uses a sampling rate of 100 Hz with default low-pass filter cut-off frequency of 74 Hz (non-configurable), with the configured high-pass filter cut-off frequency as 2 Hz. Therefore, the bandwidth is 2 Hz-74 Hz.

```
TABLE 2
PIC12F1840 initiation function:
    void pic1840_system_init( ){
  ANSELA=0x00; //all pins set as Digital I/O pins
  SSP1IE=0;//forbid interrupt
  PIR1bits.SSP1IF=0;//PIR1 bit, SSP1IE=0;
  INTCON=0;//all 0 then setup one by one
  INTCONbits.GIE=0;// Global interrupt disabled first, will set
  after system init
  SSP1CON1bits.SSPEN=1;//Enable SPI
  SSP1CON1bits.SSPM=0b0000;//clock =Fosc/4
  SSP1STAT=0x00;
    //SST25 need SPI mode 0 and LIS331 needs SPI mode 3,first set
    SPI mode 3 for
LIS331HH
//switching to SPI mode 0 and back in SST25 codes
  SSP1CON1bits.CKP=1;
  SSP1STATbits.CKE=0;
  SSP1STATbits.SMP=0;//sampling at middle
  //bit5--bit0 -->TRISA5---TRISA0
  TRISA=0b00001100;// SDO/RA0 and SPC/SCK/RA1,RA4 and
  RA5 are outputs all others as
inputs
WPUA = 1; //All RAx are weak pull up }
void interrupt_init(void){
  //set RA3 as Lis331's interrupt input pin
  IOCAP3 = 1; //allow positive edge interrupt
  INTCONbits.IOCIE = 1; //enable the Interrupt On Change
  INTCONbits.PEIE = 1; //enable peripheral device interrupt
  INTCONbits.GIE = 1; // global interrupt enabled
  IOCAF3 = 0; //clear corresponding interrupt flag;
  RA3=0;}
```

The data processing software, computer program product 130, is developed using Java and transfers the binary acceleration data file into a text file computer 120. In the continuing example, the acceleration data is calibrated, filtered, and integrated twice by the computer program product 130 executing on computer 120 to get the position over time in x, y, and z directions. The path that the data logger 110 travels can be visualized on the screen of a PC. Recorded raw data in SPI serial memory are in gravity units. In the embodiment of the continuing example, the acceleration data is are read out from the memory 114b (after opening the containment vessel 110) the using an SF600 SPI memory programmer, via clips attached to the memory 114b, and stored into a binary file on the computer 120.

In the continuing example, the process for determining position in x, y, and z directions proceeds as follows. The computer program product 120 converts the acceleration data from binary to decimal; transfers the decimal data from gravity units to acceleration (m/s²); calibrates (determines and removes) the accelerometer 113 bias; filters the calibrated data using both a moving-average filter and a low pass filter; and integrates twice over time to compute velocity and then position.

Java is used to develop the computer program product 130, which implements the outlined method and is used to process test data. Before starting each test, each data logger 110 rested for about one minute, recording 3600 samples (60 seconds×100 samples/second). The rest period data was averaged and used to compute the bias in the x_{b}, y_{b}, and z_{b} axes subtracting x_{b}, y_{b}, and z_{b} respectively, from all the samples. The next step was to filter out the noise and finally to compute velocity and distance in x, y, and z directions.

Each 256-byte page of memory 114b in the continuing example only used 252 bytes, so the last four bytes have nothing written to them. When reading binary file, if the page address is 252 then computer program product 130 will add 4 to it and force the file to jump to the beginning (0) of next page to read. Each time computer program product 130 reads six bytes and merges them into three 16-bit accelerations for the x, y, and z axes respectively. The configured scale of accelerometer 113 in the data logger 110 is {−6 g, +6 g}. The accelerometer 113 provides 16-bit data output, i.e. the raw data is assigned a 16-bit integer in the gravity unit “g”, the lowest 4 bits of the data are 0x0000. First, the raw data must be scaled into the configured range {−6 g, +6 g}. Sixteen-bit data has 65,536 values (though the lowest 4 bits are always zero), so the scale should be 6−(−6)/65,536=0.00018310546875; i.e., one LSB=0.00018310546875 g. Because, on average, g=9.81 m/s², we have one LSB=0.00018310546875×9.81=0.0017962646484375 m/s². Raw data (assigned an integer in g units) can be transferred to an assigned decimal float in m/s² units with Equation (1) where “Raw” is raw acceleration data in the 16-bit assigned binary integer. The C code is presented in Table 3.

m/s²=Gravity*12/(2¹⁶)*Raw=0.0017962646484375*Raw (1)

```
TABLE 3
“Gravity” is 9.81 m/s² .
Below are codes for reading, merging scaling and
For (int i=0,j=0;i<Raw_Data_Length−6;i=i+6,j++){
//convert raw data to “signed short” and
//store into double array in double format which is easier for
later processing
//merge two bytes into a test value(2′complement in short format)
// identify if there is no data written into it then stop converting data!
  //normally the first byte's (X1 byte ) lower digits of each
sampled data(6 bytes Xl Xh Yl Yh Zl Zh) must be zero (0000)
    //if it is F (1111) that means no valid data!
    if((aInput[i]& 0x0f)==0x0f){break;}
    totalData++;
      //X --acceleration
    leftByte=aInput[i]& 0xff;
    rightByte=aInput[i+1] & 0xff;
    value=(short)(rightByte<<8 | leftByte<<0);
      //value=value−
      xyzresult[j][0]= ((double) value)*MeterSecond2_6G;
      xyzshort[j][0]= value;
    //Y --Acceleration
      leftByte=aInput[i+2]& 0xff;
    rightByte=aInput[i+3] & 0xff;
    value=(short)(rightByte<<8 | leftByte<<0);
      xyzresult[j][1]= ((double) value)*MeterSecond2_6G;
    xyzshort[j][1]= value;
    //Z --Acceleration
    leftByte=aInput[i+4]& 0xff;
    rightByte=aInput[i+5]& 0xff;
    value=(short)(rightByte<<8 | leftByte<<0);
      xyzresult[j][2]= ((double) value)*MeterSecond2_6G;
      xyzshort[j][2]= value;
    }
```

Bias in the accelerometer 113 output will cause a shift in the measured accelerations from its true values. Biases are differences between an accelerometer's 113 expected output and its measured output, which show up consistently every time a new measurement is taken. Such errors that are repeatable can be determined during calibration, so that during actual end-use the measurements made by the data logger 110 can be compensated by the computer program product 130 to mitigate such errors. Calibration can enhance performance by improving the overall accuracy of the underlying accelerometer 113. Most low-cost MEMS sensors available on the market fall into a performance category known as automotive grade sensors. The use of the term automotive grade in this context does not necessarily imply that the sensor meets specific performance standards specific to the automotive industry. The origin of the term automotive grade when discussing MEMS sensor performance likely has to do with the fact that the automotive industry was one of the first to utilize MEMS inertial sensors in large volume. This performance grade is also sometimes referred to as consumer grade. The accelerometer 113 of the continuing example is one of automotive/consumer grade sensors. Acceleration bias-caused error in horizontal position can be calculated by Equation (2).

HPe=0.5*Bias*T*T (2)

Table 4 shows the difference between the errors caused specifically by accelerometer bias after calibration for both industrial and automotive grade sensors.

TABLE 4
Error Differences for Sensors

| | Accelerometer | | | | |
|---|---|---|---|---|---|
| | Bias Error | Horizontal Position Error | | | |
| Grade | [mg] | 1 sec | 5 sec | 10 sec | 20 sec |
| Industrial | 3 | 15 mm | 370 mm | 1.5 m | 5.9 m |
| Automotive | 125 | 700 mm | 18 m | 70 m | 280 m |

According to the datasheet of the LIS331, its bias (TyOff—Typical zero-g level offset accuracy) error is about +/−75 mg/s typically, which means its horizontal position error in one seconds and three seconds would be If T=1, then HPe=0.5*70 mg*1*1=0.5*0.070*9.8=0.343 meter; If T=3, then HPe=0.353*3*3=3.087 meter.

Lab tests showed the LIS331's output is in the range of {−70 mg, 70 mg} when the data logger 110 is at rest; that means the output shows the at-rest data logger 110 is moving. The errors caused mainly by bias are TyOff (Typical zero-g level offset accuracy±70 mg) and TCOff (Zero-g level change vs. Temperature±0.4 mg/° C.).

To achieve better performance bias can be removed from the output before integrating to get velocity/position.

The calibration process used in the continuing example is as follows: power on data logger 110, leave it at rest for about a minute, power off data logger 110, offload the acceleration data into computer 120, calculate the average of all data for each axis, and store these values as bias and let real_acceleration=(rawdata−bias). For one data logger 110 prototype, the prototype's battery was turned on and left at rest for about 50 minutes; the raw data were then transferred to the computer 120.

The accelerations in x, y, and z directions are between −0.15 mg−+0.25 mg biased and can be calibrated using the formula: Bias X=(RawX(1)+ . . . +RawX (N))/N. The same process is also applied for y and z axes.

BiasX=0.04506964516908977=45.0 mm/second²

BiasY=0.05384817218743698=53.8 mm/second²

BiasZ=0.03965850777160196=39.7 mm/second²

These biases can then be used to calibrate the data using the following relationship: calibrated_data=raw_data−bias.

Temperature can also affect the readings. TCOff (Zero-g level change vs. temperature)=(Max delta from 25° C.)=±0.4 mg/° C. If the test environment temperature is 65° C., that will be 8 mg compensating for the errors caused by temperature, which usually requires a thermal sensor.

To address the effects of temperature change, the data logger 110 is instead rested for 30 seconds and data is recorded just after powering on and before placing it into the test environment. The 30 seconds data at rest is used to calibrate accelerometer 113 and reduce the bias, which includes TyOff and TCOff. In the continuing example, two filters are used in the computer program product 130—a moving average filter and a low-pass filter. The moving average filter is described by Equation (3) and the low-pass filter is described by Equation (4)

$$\begin{matrix}{\overline{x}}_{k} = \frac{1}{n} {\sum }_{i = k - n + 1}^{k} {x}_{i} & ( 3 ) \\ {\overline{x}}_{k} = α {\overline{x}}_{k - 1} + ( 1 - α ) {x}_{k} & ( 4 )\end{matrix}$$

Both the moving average filter and the first-order low-pass filter are applied to the calibrated data one after another. After calibration and filtering, the data become smoother and the noise values fall, typically in a range of {−5 mg/s², +10 mg/s²}, which is much smaller than in the noise present in the raw data.

After the transformation and calibration, a low-pass/Kalman filter is applied to the transformed and calibrated data, then the filtered acceleration data is integrated once to get velocity and again to get the distance (path/position). The Java code used is as follows Table 5.

```
TABLE 5
  for(i=0;i<Filtered_Data_Length−1;i++)
{//First integration---->computing
//Velocity: 0 1 2 indicate x y z axis
  //delta t=1/100 = 0.01 second
V[i+1][0]=V[i][0]+(A[i][0]+A[i+1][0]) *0.5*Delta_T;
V[i+1][1]=V[i][1]+(A[i][1]+A[i+1][1]) *0.5*Delta_T;
V[i+1][2]=V[i][2]+(A[i][2]+A[i+1][2]) *0.5*Delta_T;
    //Second integration---->computing //position: 0 1 2 indicate x y z axis
P[i+1][0]=P[i][0]+(V[i][0]+V[i+1][0]) *0.5*Delta_T;
P[i+1][1]=P[i][1]+(V[i][1]+V[i+1][1]) *0.5*Delta_T;
P[i+1][2]=P[i][2]+(V[i][2]+V[i+1][2])*0.5*Delta_T; }
```

The communications connections illustrated are examples and other means of establishing a communications link between the elements can be used. Moreover, those having ordinary skill in the art having the benefit of the present disclosure will appreciate that the devices illustrated in FIG. 1 may have any of several other suitable system configurations.

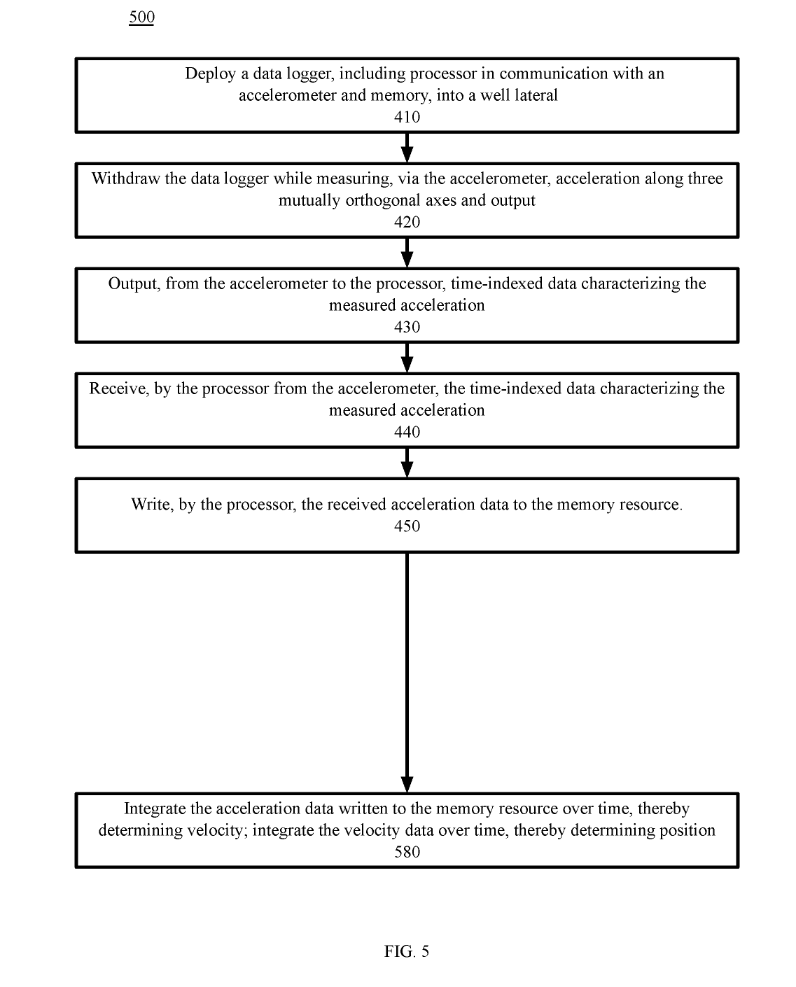

In example embodiments, the devices, and any computing machines associated with the technology presented herein, may be any type of computing machine such as, but not limited to, those discussed in more detail with respect to FIG. 5. Furthermore, any modules associated with any of these computing machines, such as modules described herein or any other modules (scripts, web content, software, firmware, or hardware) associated with the technology presented herein may be any of the modules discussed in more detail with respect to FIG. 5. The computing machines discussed herein may communicate with one another as well as other computer machines or communication systems over one or more networks. The network may include any type of data or communications network, including any of the network technology discussed with respect to FIG. 5.

The example methods illustrated in the figures are described hereinafter with respect to the components of the example system 100. The example methods also can be performed with other systems and in other environments. The operations described with respect to any of the figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

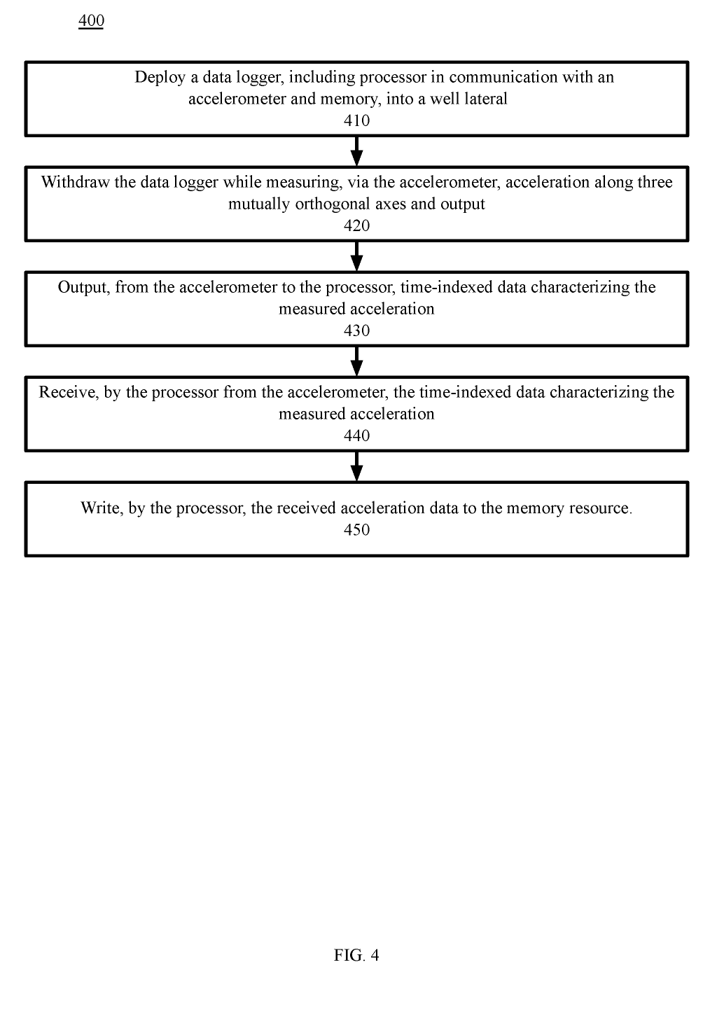

Referring to FIG. 4, and continuing to refer to prior figures for context, a block flow diagram depicting a method 400 to measure characteristics of a well lateral, in accordance with certain example embodiments is shown.

In such a method 400, a data logger 100, such as the data logger 100 described in connection with FIG. 1-FIG. 3 is deployed into a well lateral—Block 410. In a continuing example process, after deploying a mechanical lateral drilling systems in a cased well, a milling bit is deployed downhole and used to create a hole in the casing. After creating a hole in the casing, the milling bit is pulled and a lateral drill is attached and run downhole. The lateral drill string creates the hole in the casing by utilizing a rotating, mechanical drill bit on the end of the lateral drill string. After withdrawing the lateral drill string, a measurement tool string, including the data logger 100 is deployed downhole.

The data logger 100 is withdrawn while measuring, via the accelerometer, acceleration along three mutually orthogonal axes and output—Block 420. In the continuing example, the control firmware resident in the program memory 114a is executed by the processor 112 to configure the processor, configure the accelerometer 113, and enable the data memory 114b, as described above. The configured accelerometer measures acceleration, as it is withdrawn from the lateral.

The accelerometer outputs data characterizing the measured acceleration—Block 430. As the accelerometer 113 measures acceleration, the accelerometer establishes a data ready signal on the SPI bus for the processor 112. The processor 112 receives, over the SPI bus from the accelerometer, the data characterizing the measured acceleration—Block 440. The processor then writes, again over the SPI bus, the received acceleration data to the data memory 114b. The processor 112 then waits again for the data ready signal from the accelerometer 113 to begin to receive additional acceleration data from the accelerometer 113.

Referring to FIG. 5, and continuing to refer to prior figures for context, a block flow diagram depicting a method 500 to measure characteristics of a well lateral, in accordance with certain example embodiments is shown. In such embodiments, Blocks 410-450 are performed in the manner described above, with the data logger 110 including instructions to integrate the acceleration data written to the memory 114b over time, thereby determining velocity data of the data logger 100, and to integrate the velocity data over time, thereby determining position data of the data logger. The computer 120 integrates the acceleration data, thereby determining velocity data, and integrates the velocity data, thereby determining position data of the data logger 110—Block 580.

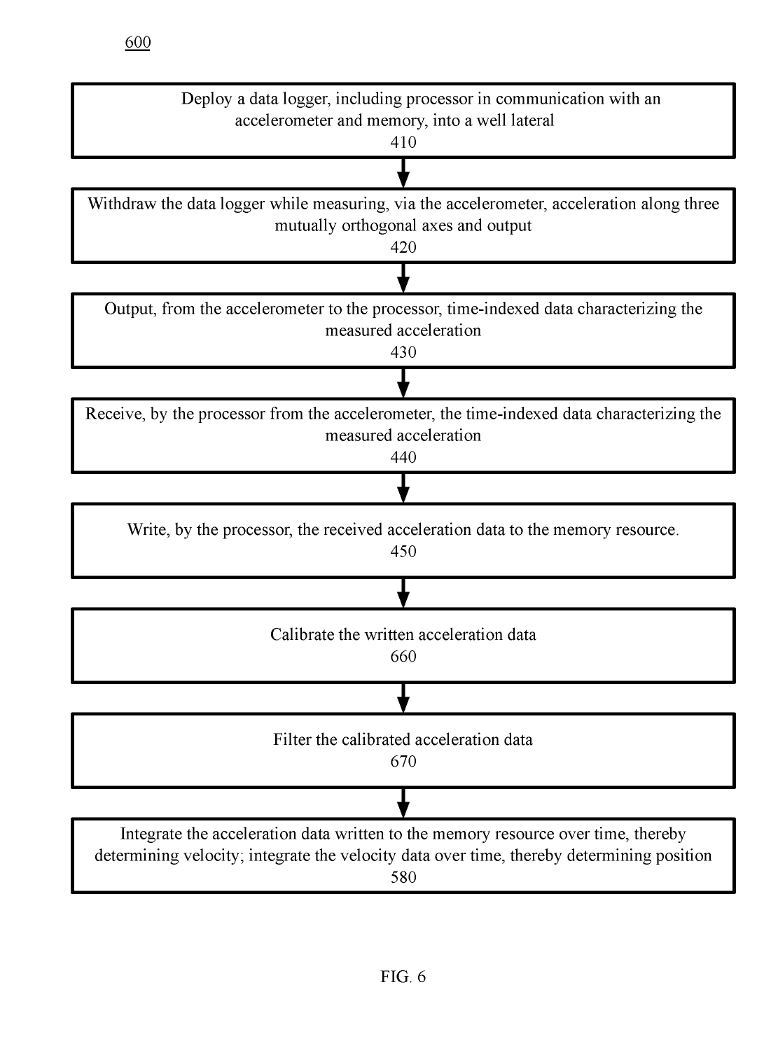

Referring to FIG. 6, and continuing to refer to prior figures for context, a block flow diagram depicting a method 600 to measure characteristics of a well lateral, in accordance with certain example embodiments is shown. In such embodiments, Blocks 410-450 and Block 580 are performed in the manner described above, with the data logger 110 including instructions to calibrate, prior to integrating the acceleration data, the acceleration data. The computer 120 calibrates the acceleration data as described above, thereby reducing the effects of systemic bias on the acceleration data—Block 660. The program memory 114a of the data logger 100 also includes computer-executable instructions for the processor to filter, before integrating the acceleration data, the calibrated acceleration data. The processor 112, before integrating the acceleration data, filters the calibrated acceleration data—Block 670.

### Other Example Embodiments

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments previously are illustrative, and, in alternative embodiments, certain acts can be performed in a different order, in parallel, omitted entirely, and/or combined between different embodiments, and/or certain additional acts can be performed, without departing from the scope and spirit of embodiments. Accordingly, such alternative embodiments are included in the scope of the claims, which are to be accorded the broadest interpretation to encompass such embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A downhole measurement system, comprising:
a data logger, comprising:
a containment vessel characterized by a radial dimension less the diameter of a hole to be measured;
a processor, housed in the containment vessel and operative to execute processor-readable instructions;
an accelerometer housed in the containment vessel, in data communication with the processor, and operative to measure acceleration along three mutually orthogonal axes and output, to the processor, data characterizing the measured acceleration; and
memory housed in the containment vessel, in data communication with the processor, and storing processor-readable instructions;
wherein the stored instructions comprise processor-readable instructions, that when executed by the processor, cause the processor to receive the outputted acceleration data and write the received acceleration data to the memory.

2. The downhole measurement system of claim 1 wherein the data communication between the processor, accelerometer, and memory is one of serial peripheral interface (SPI) and an Inter-Integrated Circuit (I2C).

3. The downhole measurement system of claim 1 further comprising a computer program product, the computer program product comprising:
a non-transitory computer-readable storage device having computer-executable program instructions embodied thereon that when executed by a computer cause the computer to determine spatial characteristics of the measured hole as a function of acceleration data written to the memory, the computer-executable program instructions comprising:
computer-executable program instructions to integrate the acceleration data written to the memory over time, thereby determining velocity data of the data logger; and
computer-executable program instructions to integrate the velocity data over time, thereby determining position data of the data logger.

4. The downhole measurement system of claim 0 further wherein the computer-executable instructions further comprise computer-executable instructions to calibrate the acceleration data prior to integrating the acceleration data.

5. The downhole measurement system of claim 4 further wherein the computer-executable instructions further comprise computer-executable instructions to filter the calibrated acceleration data prior to integrating the acceleration data.

6. The downhole measurement system of claim 5, wherein filtering the calibrated acceleration data comprises at least one of moving average filtering the acceleration data, and low pass filtering the moving-average filtered data.

7. The downhole measurement system of claim 1,
further comprising a printed circuit board,
wherein:
the processor, the memory, and the accelerometer are mounted on the printed circuit board; and
the printed circuit board includes conductors implementing the communication between the processor and the memory, and the communication between the processor and the accelerometer.

8. A method to measure characteristics of a well lateral, the method comprising:
deploying a data logger into a well lateral, the data logger comprising:
a containment vessel characterized by a radial dimension less the diameter of a hole to be measured;
a processor, housed in the containment vessel and operative to execute processor-readable instructions;
an accelerometer housed in the containment vessel, in data communication with the processor, and operative to measure acceleration along three mutually orthogonal axes and output, to the processor, data characterizing the measured acceleration; and
a memory housed in the containment vessel, in data communication with the processor, and storing processor-executable instructions; and
wherein the stored instructions comprise processor executable instructions causing the processor to receive the outputted acceleration data and write the received acceleration data to the memory;
withdrawing the data logger while measuring, via the accelerometer, acceleration along three mutually orthogonal axes and output;
outputting, from the accelerometer to the processor, data characterizing the measured acceleration;
receiving, by the processor from the accelerometer, the data characterizing the measured acceleration; and
writing, by the processor, the received acceleration data to the memory.

9. The method of claim 8 wherein the data communication between the processor, accelerometer, and memory is one of serial peripheral interface (SPI) and an Inter-Integrated Circuit (I2C).

10. The method of claim 8, further comprising:
providing a non-transitory computer-readable storage device having computer-executable program instructions embodied thereon that when executed by a computer cause the computer to determine spatial characteristics of the measured hole as a function of acceleration data written to the memory, the computer-executable program instructions comprising:
computer-executable program instructions to integrate the acceleration data written to the memory over time, thereby determining velocity data of the data logger; and
computer-executable program instructions to integrate the velocity data over time, thereby determining position data of the data logger;
executing, by the computer, the computer computer-executable program instructions to integrate the acceleration data written to the memory over time, thereby determining velocity data of the data logger; and
executing, by the computer, the computer-executable program instructions to integrate the velocity data over time, thereby determining position data of the data logger.

11. The method of claim 10:
wherein the computer-executable instructions further comprise computer-executable instructions to, prior to integrating the acceleration data, calibrate the acceleration data; and
the method further comprises executing, by the computer, the computer computer-executable instructions to calibrate, prior to integrating the acceleration data, the acceleration data.

12. The method of claim 11:
wherein the computer-executable instructions further comprise computer-executable instructions to, prior to integrating the acceleration data, filter the calibrated acceleration data; and
the method further comprises executing, by the computer, the computer computer-executable instructions to filter, prior to integrating the acceleration data, the acceleration data.

13. The method of claim 12, wherein filtering the calibrated acceleration data comprises at least one of moving average filtering the acceleration data, and low pass filtering the moving-average filtered data.

14. The method of claim 8, wherein:
the data logger further comprises a printed circuit board,
the processor, the memory, and the accelerometer are mounted on the printed circuit board, and
the printed circuit board includes conductors implementing the communication between the processor and the memory, and the communication between the processor and the accelerometer.
